(19) United States
(12) Patent Application Publication
(10) Pub. No.: US 2008/0270409 A1
(43) Pub. Date: Oct. 30, 2008

(54) Data, Structure, Structured Data Management System, Structured Data Management Method and Structured Data Management Program

(75) Inventors: Haruo Naito, Yamanashi (JP); Masuhiro Ohyama, Yamanashi (JP)

Correspondence Address: BIRCH STEWART KOLASCH & BIRCH, PO BOX 747, FALLS CHURCH, VA, 22040-0747, US

(73) Assignee: ATL SYSTEMS, INC., Kofu-shi (JP)

(21) Appl. No.: 11/596,467

(22) PCT Filed: Oct. 29, 2004
(86) PCT No.: PCT/JP2004/016132

§ 371 Date: Feb. 12, 2007

(30) Foreign Application Priority Data
May 11, 2004 (JP) 2004-141713

(51) Int. Cl. G06F 17/30; G06F 15/16

(52) U.S. Cl. 707/10; 709/204; 707/E17.032

(57) ABSTRACT

It is possible to easily process updates of structured data without excessive burden on servers, clients and the network to connect them.

It provides the means for dividing structured data stored on a server into at least data management information and data information, composing said data information from several data body information and assigning unique identifiers to them, allowing a client to request updates of data body information based on the identifiers, and allowing the server to attach predefined tags to the text within the data body information and send it upon said request.

### TECHNICAL FIELD OF THE INVENTION

This invention relates to a technique for updating structured data stored on a server operating with a general-purpose operating system such as a web server by a client connected through a network such as the Internet. Specifically, it relates to a data structure of a wide variety of information written in XML (extensible Markup Language), and a structured data management system, a structured data management method and a structured data management program for managing the data structure.

### BACKGROUND ART

A conventional way of updating structured data on a server by a client connected to the server through a network has generally been as follows:

FIG. 12 illustrates an example of updating the database of web server 100 by client 200. The data written in XML (hereinafter referred to as “XML data”) here are stored on server 100 as a database. The process of updating the XML data on server 100 involves downloading the XML data from server 100 by client 200, modifying the downloaded XML data with a specific input tool, and uploading the modified data to the server as XML data.

FIG. 13 is an example of a view of the input tool used when client 200 updates XML data. In FIG. 13, a hierarchical structure of downloaded XML data is displayed on the left of the window, and the contents are displayed on the right. As shown in FIG. 13, the XML data downloaded by the client from server 100 are data management information such as an XML declaration (<?xml version=“1.0” encoding=“Shift=JIS”?>) and data body information that is a document body (data following after <doc toc=“true” cover=“false”>), which are all the data including XML tags stored on server 100. That is to say, even though it is the data body information the client wants to update, the data cannot be updated on client 200 until all the information including tags attached to data body information and data management information are downloaded. In this way, it is required for updates to store all the XML data on the memory of client 200, modify a part of data body information to update on client 200, and then upload all the XML data back to server 100 again.

In the process of updating XML data, a user modifies parts of data to update while viewing tags and the data displayed on the right of the window. However, types of tags defined in XML are decided by a document type definition. And, a document type definition allows a user to extend freely a set of the rules, which causes a problem that it is not easy for a person unfamiliar with XML to share the data created by others and update them while inputting tags. Also, there is a problem that sending and receiving of all the XML data becomes an excessive burden on servers, clients and networks.

Specifically, in the case of structuring a wide variety and enormous amount of data such as administrative documents/information with XML and managing them, there are problems as follows: (1) the number of types of tags necessary for document management information (XML declaration, document type definition, namespace and so on) is exceedingly increased, and (2) if a person (user) who manages/updates administrative documents does not have technical knowledge of computers and program languages, first, data incompatible with the structured data on a server may be created, and secondly, due to an excessive burden on a server, a client, and a network, an update process can consume a lot of time.

Non-patent document 1: Cho nyumon XML (Super introduction to XML), Hiroaki OKUBO, published by Subarusya corporation, page 209.

There is a patent document of a preceding patent application, which is mentioned below, disclosing a technique of enabling to update XML data stored on a server in a short time. The technique disclosed in the patent document is such that when a client wishes to update XML data on a server, the client sends the server location data indicating the location of XML data to update, identification data indicating an update type and values indicating elements to add or elements after updates (an update command including data), and then the server updates the XML data according to the update command sent from the client.

However, even with the technique, the data to be displayed are XML data themselves (FIG. 7, FIG. 8 in Japanese patent application publication No. 2002-123418) as the technique in the aforementioned non-patent document, because of which it is not easy for a user with little knowledge about XML to update documents. In addition, the technique disclosed in the patent document is for a defining XML data format such as to manage an organization, its departments and names of people belonging to the organization as a database, so it is assumed for the updates within the range of definition. For example, it is intended to update XML data in the form of job cards (FIG. 12, FIG. 13 in Japanese patent application publication No. 2002-123418), such as updating Yamamoto, Taro among “<employee> Yamamoto, Taro <employee>”. Therefore, there is a problem that it is not easy for people having no technical knowledge about computer program languages such as XML, for example, to share and update a wide variety and enormous amount of administrative documents managed by a municipality.

Patent document 2: Japanese patent application publication No. 2002-123418

### DISCLOSURE OF THE INVENTION

### Problems to be Solved by the Invention

Therefore, the present invention has an object to provide a data structure, a data management system, a data management method and a data management program, making update processes easy for a person with no technical knowledge about computer program languages such as XML without concern for structured data on a server, as well as without excessive burden on a server, a client and the network to connect them when managing and updating structured data, particularly a wide variety of documents.

### Means for Solving the Problems

Specific aspects of the present invention to achieve the object will be described below.

The first aspect of the present invention is a data structure of data stored on a server and updated by a client connected to the server through a network, in which the data structure is hierarchized into at least data management information and data information, both attached with unique identifiers, the data information is further hierarchized into at least a plurality of blocks attached with unique identifiers, and the each of the blocks includes data body information written in a language displayable by a web browser.

It is preferable that the data structure is written in XML. Also, it is preferable that the data body information is written in XTML or XHTML.

It is preferable that the data information is hierarchized into at least a plurality of sections attached with unique identifiers, and the blocks are arranged under the respective sections.

The data structure mentioned above enables to directly specify data that a client wants to update within data stored on a server. Then the specified data to update are divided into sections and included in respective blocks under the sections as data body information written in a language displayable by a web browser, which enables quick and easy data updates between the server and the client.

The second aspect of the invention is a structured data management system including a server having hierarchically structured data, and a client connecting to the server through a network and updating the structured data on the server, in which the structured data are hierarchized into at least data management information and data information, the data information includes a plurality of data body information pieces each of which is attached with a unique identifier, the client has means for making a request to update a data body information piece based on the unique identifier, the server has means for, in response to the request, sending a text within the data body information piece and predefined tags attached to the text, and the client has means for receiving the text with the predefined tags sent from the server (hereinafter referred to as “sent-tagged text”), displaying the text and accepting updates, and means for, when the text is updated, sending data of the text attached with the predefined tags (hereinafter referred to as “received-tagged text”).

The data management information is necessary to manage data stored on a server, such as information identifying clients, information specifying data to update, and data creator and creation date. Data information is the root node of data body information comprising plural data body information pieces. A unique identifier is only one defined identification number used by a client to specify data on the server, and which attached to data information under the data structure as above, enables the client to easily specify the node where the data to update exist.

In the present invention, the client has means for requesting updates of data body information based on the identifiers, and the server has means for attaching predefined tags to the text within the data body information and sending it upon the request.

Data body information includes the (body) text of data stored on a server, and the text is data including tags remained after removing tags of the current node from the data body information and it is the text of a document. Predefined tags are minimum tags required to update the text on a client when the server sends the text to the client.

The client has means for receiving the text that is attached with the predefined tags and sent from the server (hereinafter referred to as “sent-tagged text”), displaying the text and accepting updates, and means for, when the text is updated, attaching predefined tags to the text and sending the tagged text to the server (hereinafter referred to as “received-tagged text”).

This configuration enables to achieve data updates between a server and a client through attaching minimum tags to data to update, and also enables easy data updates even for a person with little technical knowledge about structured data written in XML.

The server further has means for, upon request from the client to update a plurality of data body information pieces based on the identifiers, combining texts within the data body information pieces into one tagged text and sending it to the client.

When the plurality of data body information pieces is specified by the client, the server sends respective texts as one text. In this way, the client can view and update the plural texts in a single operation.

It is preferable that the structured data stored on the server are data written in XML, and additionally, the server has means for determining the compatibility of the received-tagged text sent from the client with its stored structured data, and further means for, if not compatible, notifying the client of incompatibility or, if compatible, updating the data body information by the received-tagged text.

The invention enables a person with little knowledge of XML to update a document displayed on a client computer as if using a word processor, and also to update a document without concerning the XML data structure of a server.

The third aspect of the invention is a structured data management method in a system where a server having structured data and a client updating the structured data on the server are interconnected through a network, comprising:

hierarchizing the structured data into at least data management information and data information;

dividing the data information into a plurality of data body information pieces and assigning each of the data body information pieces with a unique identifier;

allowing the client to make a request to update a data body information piece based on the unique identifier,

allowing the server, upon receiving the request, to send a text within the data body information piece with predefined tags attached to the text;

allowing the client to receive the text attached with the predefined tags sent from the server (hereinafter referred to as “sent-tagged text”), display the text within the sent-tagged text on a display device and accept updates, and when the text is updated, to send data of the text updated with the predefined tags to the server (hereinafter referred to as “received-tagged text”); and

allowing the server to update the data body information piece by the received-tagged text.

The server, when updating its data by the updated and received tagged text, determines the compatibility of the received-tagged text with its structured data, and if not, notify the client of it, or if compatible, update them. If the request from the client is for updates of a plurality of data body information pieces, the server combines texts within the data body information pieces into one text and sends it as a sent-tagged text.

The structured data management method enables to achieve data updates between a server and a client in the form of attaching minimum tags to data to update, and also enables easy data updates for a person with little technical knowledge about structured data as represented by data written in XML.

The fourth aspect of the invention is a program allowing a server for managing hierarchical structured data to function as means for hierarchizing the structured data stored on the server into at least data management information and data information, means for assigning a unique identifiers to each of data body information pieces composing the data information, means for accepting a request from a client interconnected through a network to update a data body information piece based on the unique identifier, and means for attaching predefined tags to a text within the data body information piece and sending it to the client on the request for updates.

Further, the program allows a client interconnected with the server through the network to function as means for receiving the text attached with the predefined tags and sent from the server (hereinafter referred to as “sent-tagged text”), means for receiving the sent-tagged text, displaying the text within the sent-tagged text and accepting updates, and means for sending the text updated and attached with predefined tags to the server (hereinafter referred to as “received-tagged text”).

Furthermore, the program allows the server to function as means for, upon request from the client to update the plurality of data body information pieces based on respective identifiers, combining texts within the data body information pieces into one text, and sending it to the client as a sent-tagged text. Also, the program allows the server to function as means for receiving a (received-)tagged text and determining the compatibility of the received-tagged text with its stored structured data, and means for, if not compatible, notifying the client of incompatibility or, if compatible, updating the data body information by the received-tagged text.

This program enables to achieve data updates between a server and a client in the form of attaching minimum tags to data to update, and also enables easy data updates for a person with little technical knowledge about structured data as represented by data written in XML.

### Effect of the Invention

The invention enables to easily select data to update among structured data stored on a server and to minimize a data volume sent and received between the server and a client, for which there is no excessive burden on the server, the client and the network. Additionally, there is no need to care about structured data, for which it provides an advantage that even a person with little technical knowledge about computers and programming languages can easily and appropriately update data.

### BRIEF DESCRIPTION OF THE DRAWINGS

FIG. 1 is an entire system configuration diagram illustrating the structured data management system of the invention;

FIG. 2 is a specific system block diagram of server 10 (according to an embodiment);

FIG. 3 illustrates details of the data structure of XML data 16 on server 10;

FIG. 4 illustrates the XML data structure of server 10 (according to the embodiment);

FIG. 5 illustrates an example of XML data on server 10 (according to the embodiment);

FIG. 6 illustrates an example of a view of XML data in FIG. 5 displayed on client 20 (according to the embodiment);

FIG. 7 illustrates an example of a view of the tagged document, which sent from the server and displayed on display unit 23 of client 20 (according to the embodiment);

FIG. 8 shows each example of a sent-tagged text and a received-tagged text (according to the embodiment);

FIG. 9 illustrates the block configuration of client 20 (according to the embodiment);

FIG. 10 illustrates the way of XHTML conversion to display two sent-tagged texts on a web browser (according to the embodiment);

FIG. 11 is a flow chart of updating the XML data on server 10 by client 20;

FIG. 12 illustrates an example of updating the database of web server 100 by client 200; and

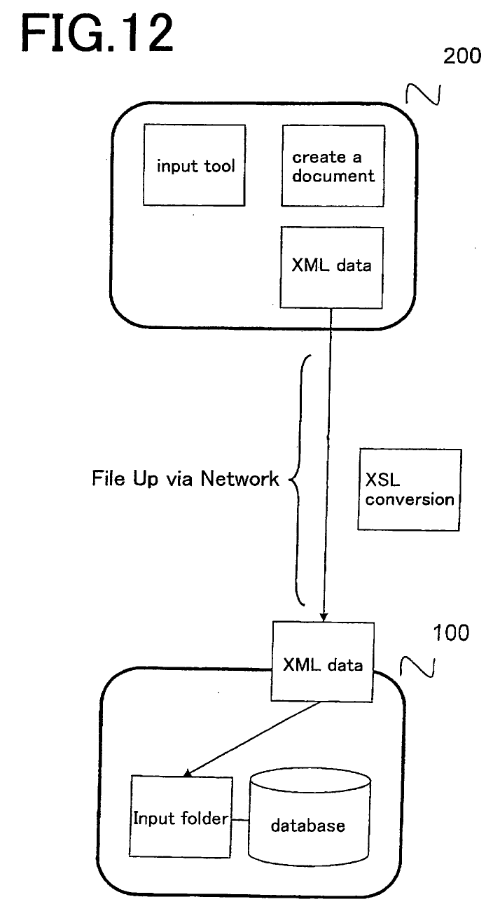

FIG. 13 is an example of a view of the input tool used when client 200 updates XML data.

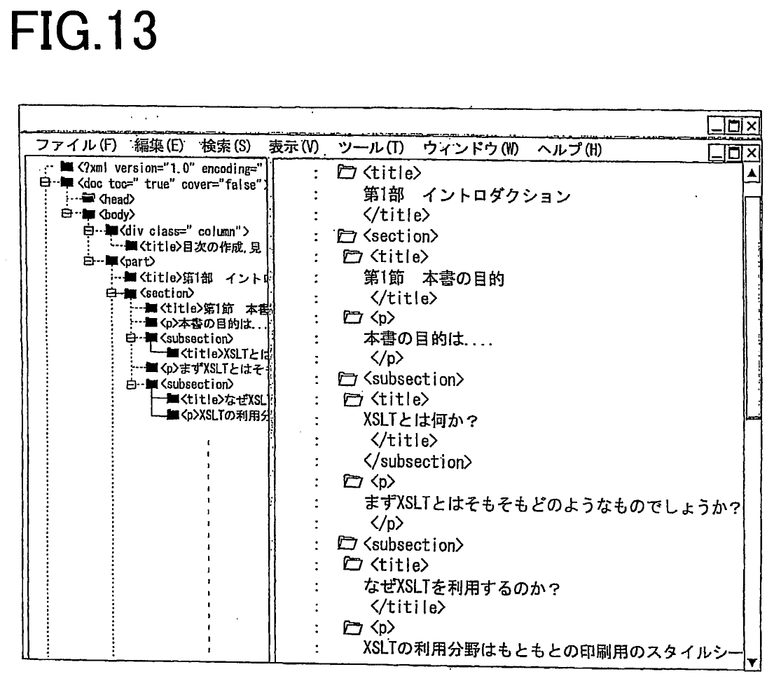

### DESCRIPTION OF THE REFERENCE NUMERALS

10: server
11: sending/receiving means
12: data for updates
13: updated data
14: update data extracting/storing/structuring means
15: compatibility checking means
16: storage device
16-1 to n: XML data
20: client
21: display/input means
22: sending/receiving means
23: display unit
30: network

### BEST MODE FOR CARRYING OUT THE INVENTION

Term definitions

The definitions of the terms used in the description are as follows.

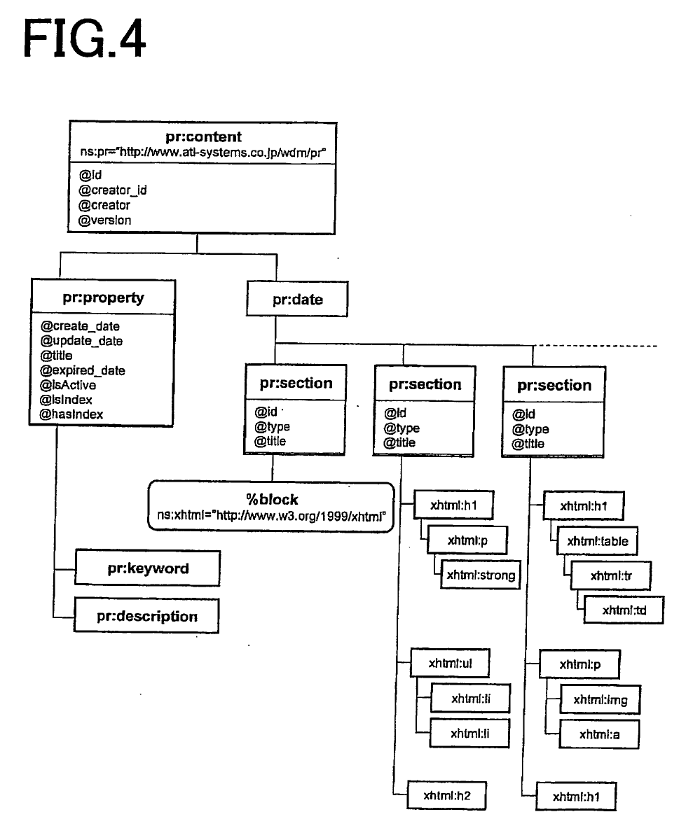

Data management information: information for identifying clients, information for identifying data to be updated, and information for managing server data such as a data creator and a creation date. This corresponds to “pr:content” in the embodiment of FIG. 4.

Data information: data under the root node and including plural pieces of data body information. This corresponds to “pr:data” in the embodiment FIG. 4.

Data body information: text of data to be updated and equivalent of child nodes of data information. This corresponds to “pr:section” and “%block” in the embodiment FIG. 4.

Unique identifier: identification number to be uniquely decided and used when a client specifies server data.

Text within data body information: data remained after tags are removed from data body information.

### Embodiment 1

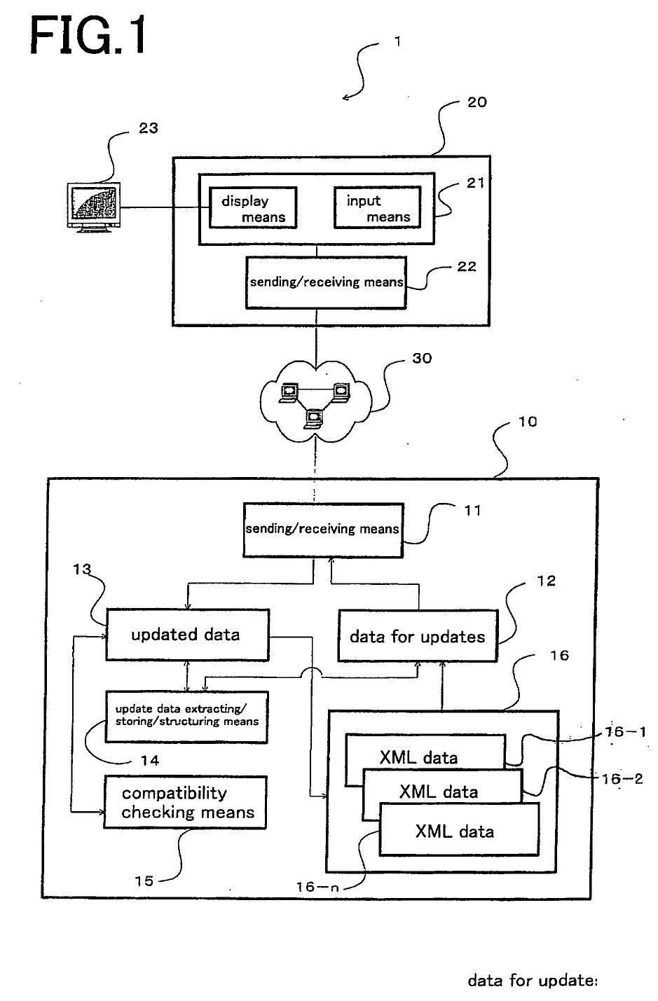

FIG. 1 is an entire system configuration diagram illustrating a structured data management system 1 of an embodiment of the present invention. Client 20 is connected to server 10, by a network such as the Internet 30. Server 10 has structured data, for example, XML data 16-1 to XML data 16-n as multiple file groups in storage device 16. Each of the XML data has a unique identifier as an attribute value. In this embodiment, data transferring means between client 20 and server 10 is, for example, HTTP (Hyper Text Transfer Protocol), the data description language is XML (Extensible Markup Language), and server 10 is a web server.

A person updating the XML data on server 10 (hereinafter called a user) can login to server 10 via client 20, and browse the XML data on server 10 as if they were web pages. The user can specify which XML data to update on server 10 after logining and inputting of a unique identifier assigned to each XML data by the display/input means 21.

When client 20 specifies XML data, server 10 extracts the specified XML data as data for updates 12 from storage device 16 by update data extracting/storing/structuring means 14. Data for updates 12 are attached with minimum tags that allow data for updates 12 to be displayed and updated on client 20, and sent to client 20 by sending/receiving means 11 (hereinafter referred to as “sent-tagged text”).

Client 20 displays a text within the sent-tagged text sent from server 10 on display unit 23 by a web browser. The text is updated by display/input means 21. The modified and updated text is attached with minimum tags necessary for updates on server 10, which is sent to server 10 (hereinafter referred to as “received-tagged text”) by sending/receiving means 22.

Update data extracting/storing/structuring means 14 of server 10 converts the received-tagged text into XML data as updated data 13. Compatibility checking means 15 checks whether a data structure of updated data 13 is compatible with the XML data structure of storage device 16 or not. If compatible, server 10 updates the XML data in storage device 16, and if not, server 10 notifies client 20 of the incompatibility.

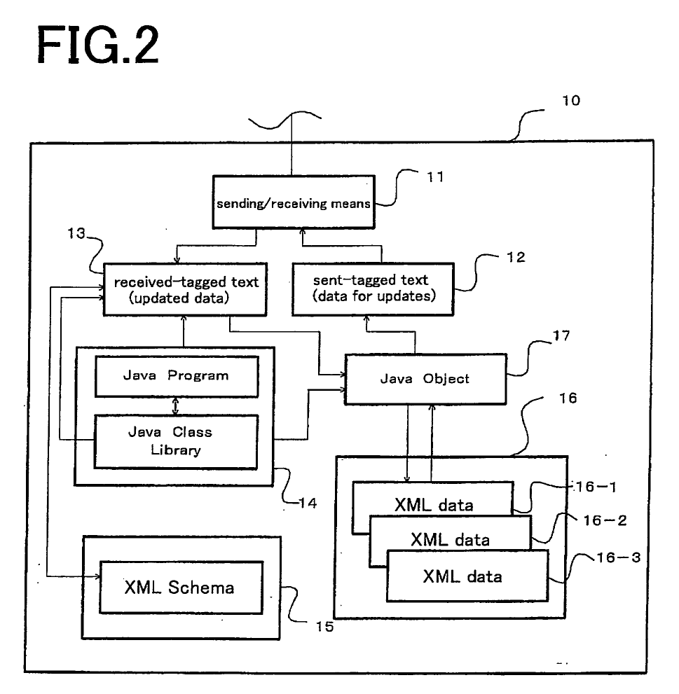

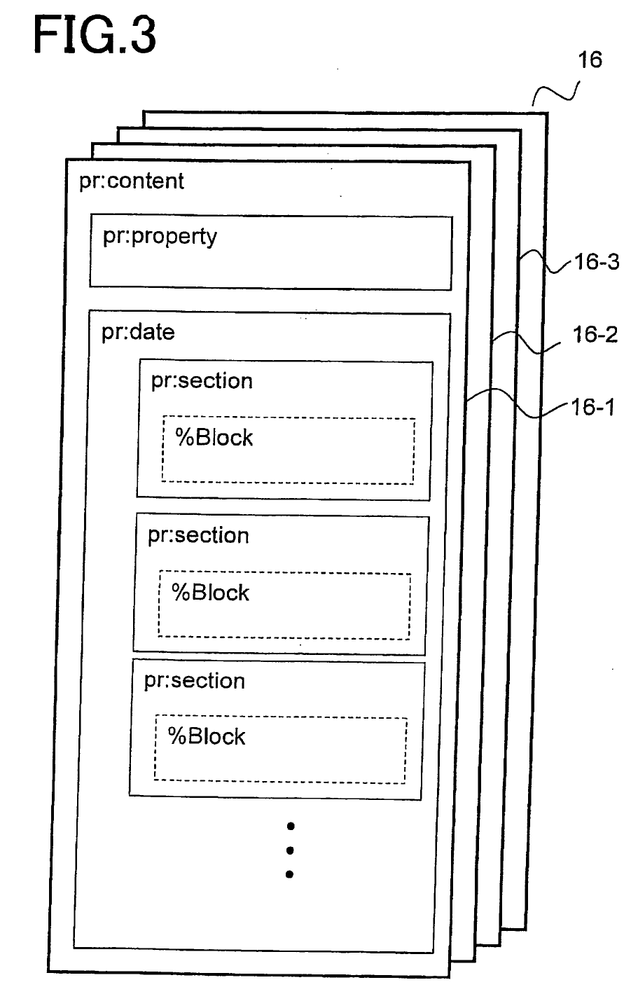

FIG. 2 illustrates a detailed block diagram of the system configuration of server 10. When XML data to be updated such as XML data 16-1 are specified on client 20, update data extracting means (Java (registered trademark of Sun Microsystems, Inc.) Program) starts and then extracts XML data 16-1 as described below. FIG. 3 illustrates the details of the data structure of XML data 16-1 to 16-n on server 10. As shown in FIG. 3, each text written in HTML or XHTML is structured to be included as “% BLOCK” in pr:section.

FIG. 4 illustrates a hierarchical structure of XML data 16 on server 10. The XML data have “pr:content” (also simply referred to as “content”) as the root node, and also have “pr:property” (also simply referred to as “property”) and “pr:data” (also simply referred to as “data”) as the child nodes under “pr:content”. The series of “property” are for describing data management information, and have “pr:keyword” and “pr:description” under “property” as in the hierarchical structure.

The series of “data” are the ones for describing data information, and have independently defined plural “sections” as the child nodes under “data” when “data” is the current node. Under each “section”, DTD controlled by a namespace (http://www.w3.org/1999/xhtml) is implemented, and “% Block” referring to part of XHTML content model as a parameter entity is deployed as a descendent node. The elements in “content” are expressed without namespace prefixes (xmlns=http://www.w3.org/1999.xhtml).

Each “section” is provided with a unique ID (identifier) as an attribute value. “Content” is also provided with a unique ID because storage device 16 stores multiple XML data. Due to these IDs, a user can specify which “section” has the desired text among multiple XML data on the server. It is preferable to specify a namespace in data management information as a way of providing unique IDs. “% Block” under “section” is an entity defined by HTML or XHTML, and linked to the text included in a “section” node as the entity reference.

In FIG. 2, XML data 16-1 specified by client 20 is once converted to Java (registered trademark of Sun Microsystems, Inc.) Object 17 by update data extracting/storing/structuring means 14. In the embodiment, update data extracting/storing/structuring means 14 is composed of Java (registered trademark of Sun Microsystems, Inc.) Program, Java (registered trademark of Sun Microsystems, Inc.) Class Library, CSS (Cascading Style Sheet) and XSL (extensible Stylesheet Language).

Java (registered trademark of Sun Microsystems, Inc.) Object 17 is converted to a sent-tagged text by update data extracting/storing/structuring means 14, and sent to client 20 by sending/receiving means 11. The sent-tagged text here is a text attached with minimum tags that enable the text within the sent-tagged text to be displayed by a general web browser with relation to Java (registered trademark of Sun Microsystems, Inc.) Script sent at the same time with the sent-tagged text to client 20 from server 10, and also enable the user to modify the text on client 20.

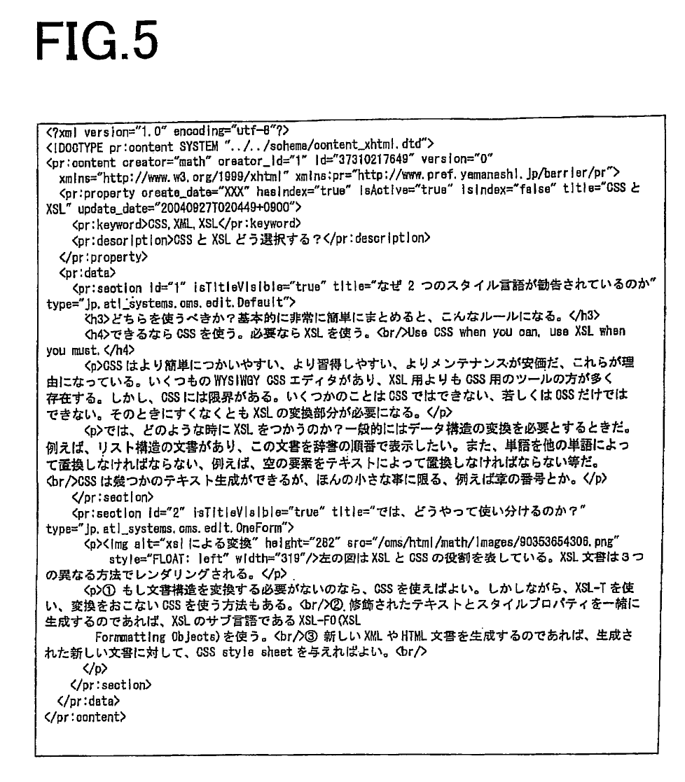

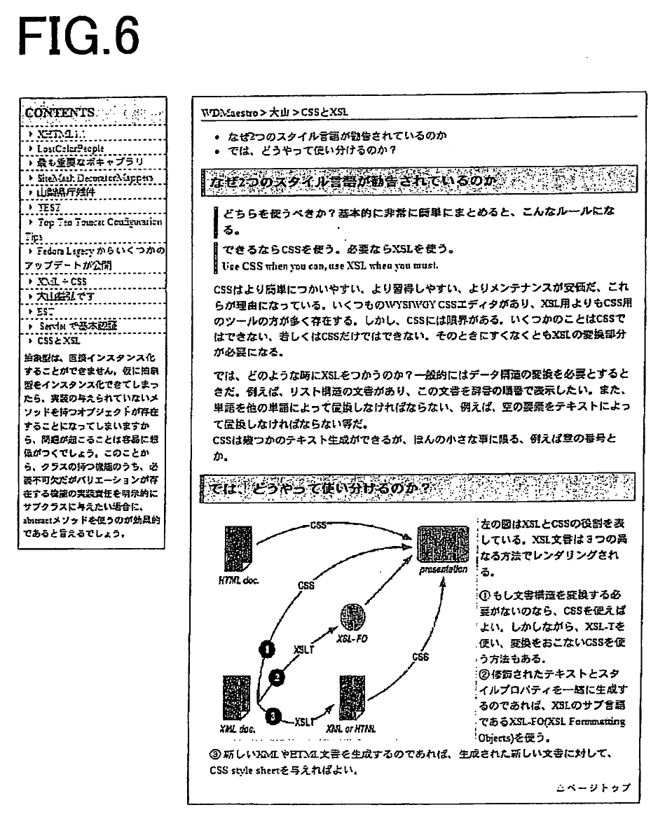

FIG. 5 is an example of a described content of XML data 16-1 to 16-n on server 10. FIG. 6 is an example of a view displayed on client 20 when XML data 16-1, for example, are sent from server 10 to client 20.

The way for client 20 to retrieve XML data 16-1 is to input id=37310217649 of pr:content id, id=1 of section 1 id, and id=2 of section 2 id as shown in FIG. 5. These enable to display the texts from Title= [symbol] [symbol] [symbol] [symbol] (“Why are two style languages recommended?”), [symbol] [symbol] [symbol] [symbol] [symbol] [symbol] (“Which one should be used? Basically, rules can be summarized like this.”) to “CSS [symbol] [symbol] [symbol] [symbol] [symbol] [symbol] (“CSS can create some texts, but limited to small matters. For example, number.”) of the text of % Block under section 1, and from [symbol] [symbol] ?” (“Then, how to use each of them according to the situation?”) to “CSS style sheet [symbol] (“All needed is to provide CSS.”) by specified of section id=2 in FIG. 5 on the screen of the display unit of client 20 as shown in FIG. 6.

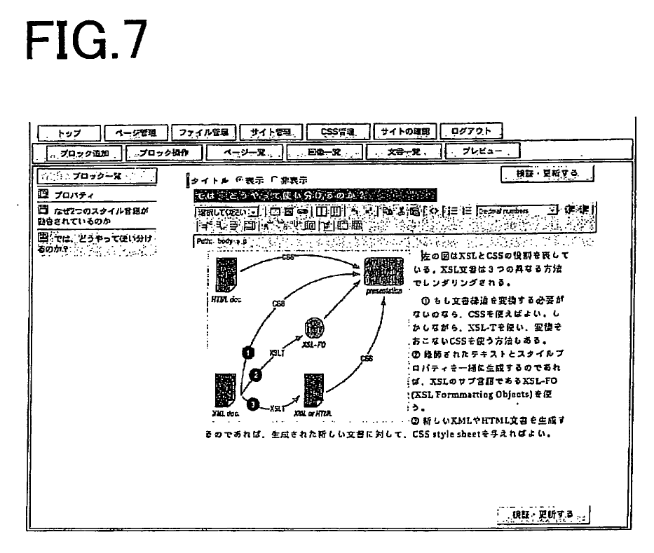

FIG. 7 is an example of a view displayed on display unit 23 when a user specifies id=37310217649 of pr:content and section id=2 on client 20.

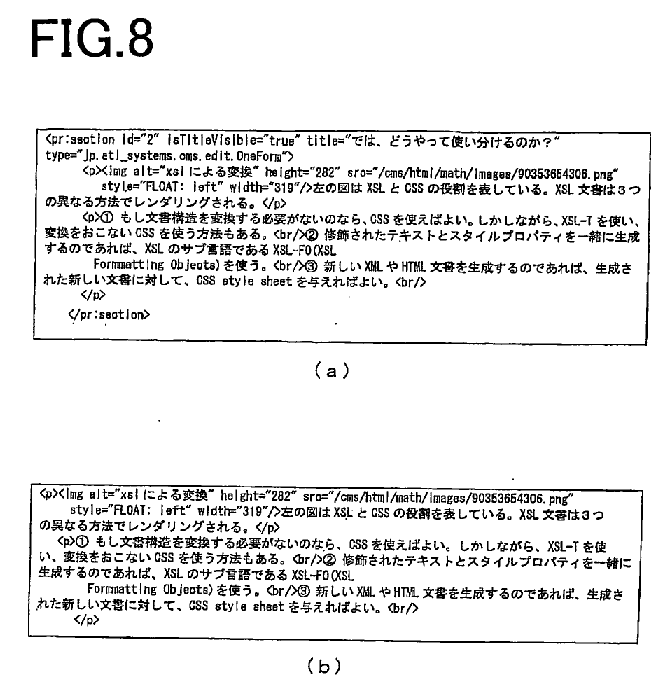

FIG. 8 (a) is an example of the sent-tagged text sent from server 10 to client 20 to display the view. The text attached with some tags, such as “pr:section id=2 is title visible=true” shown in FIG. 8 (a), is sent from server 10 to client 20, whereby the document that the user wants to update is displayed on display unit 23 as shown in FIG. 7. Then modifying it on display unit 23 and pushing the [symbol] (“verify/update”) button at the lower right in FIG. 7, the user can send the updated document to server 10.

FIG. 8 (b) is an example of the received-tagged text that is the updated document sent from client 20 to server 10. The text attached with some tags, such as img alt=”xsl [symbol] (“conversion by xsl”), is sent from client 20 to server 10.

Conventionally, it has been necessary for updating XML data to send client 20 data management information composing XML data, and various elements, attributes and attribute values needed to define “data”. On the other hand, in this embodiment, it becomes possible to send data for updates by attaching some tags to both the text and identifier of the node to update in XML data. In addition, a view displayed on client 20 can be displayed by general web browser software, such as Internet Explore, and a user can freely update the data of the text by input means 21.

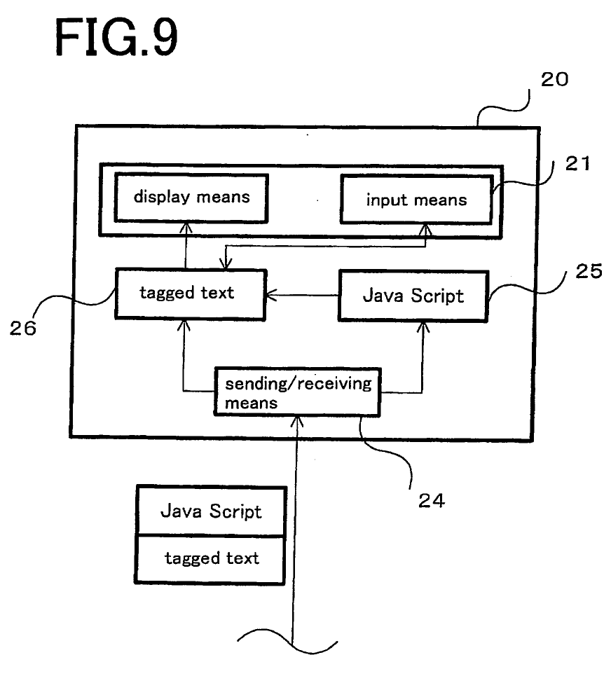

FIG. 9 is a block configuration diagram of client 20. Sending/receiving means 24 receives a sent-tagged text and JavaScript (registered trademark of Sun Microsystems, Inc.) sent from server 10. Sent-tagged text 26 received by the client is converted to XHTML by JavaScript (registered trademark of Sun Microsystems, Inc.) 25, which enables a user to modify it by display/input means 21.

In FIG. 2, compatibility checking means 15 (XML Schema) determines whether the received-tagged text sent from client 20 is compatible with the structured data (XML data) on server 10. If not compatible, server 10 notifies client 20 of the incompatibility. If compatible, update data extracting/storing/structuring means 14 (Java (registered trademark of Sun Microsystems, Inc.) Program) once converts the received-tagged text to Java (a registered trademark of Sun Microsystems, Inc.) Object 17, and then updates it as XML data 16-1 in storage device 16.

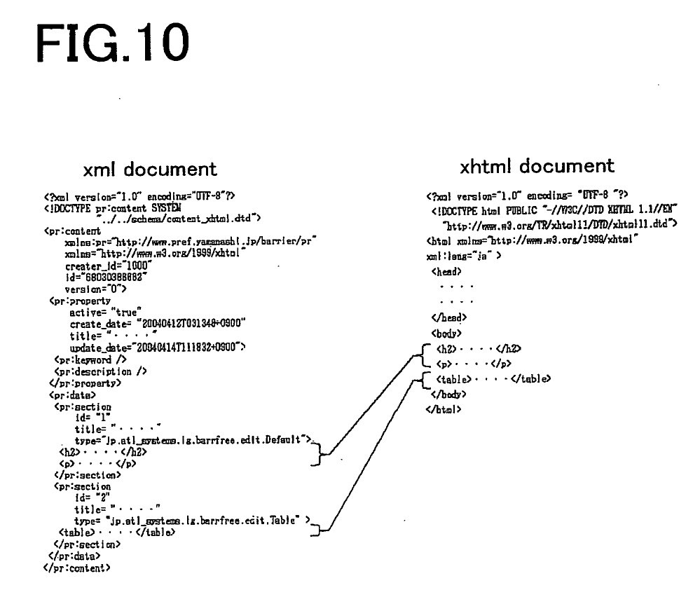

FIG. 10 illustrates the way of combining “% Block” under a section into one <body></body> tag when client 20 requests several pieces of data body information. In FIG. 10, % Block requested from a client to browse is % Block equivalent to section id=0. These two “% Block”s are automatically inserted between <body></body>, and once created as a XHTML document by update data extracting/storing/structuring means 14 (Java (a registered trademark of Sun Microsystems, Inc.) Program). And then, it is created as a sent-tagged text by being removed unnecessary tags, and sent to client 20.

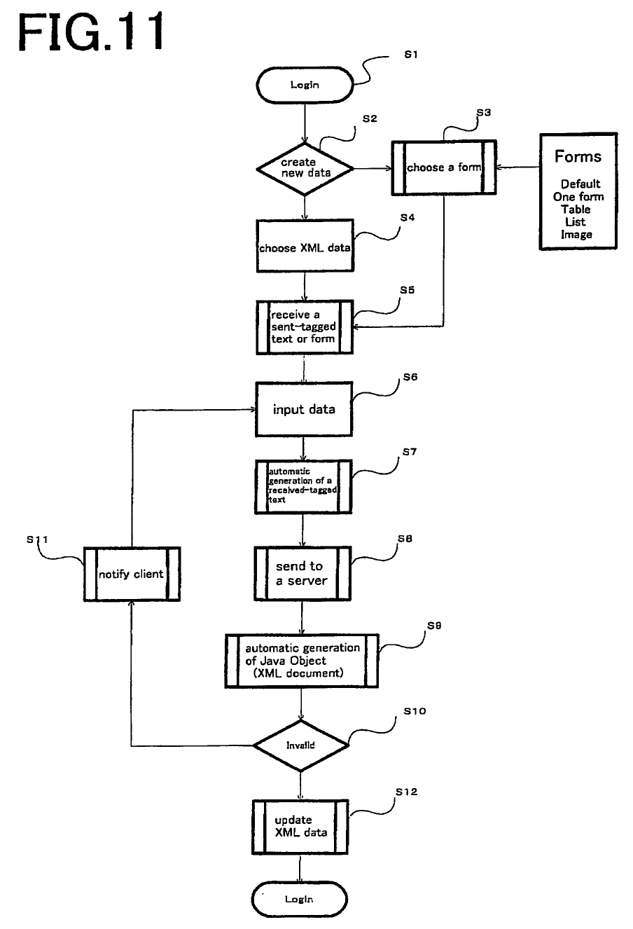

FIG. 11 is a flow chart for updating the XML data on server 10 by client 20, which explained above. A user who logins to server 10 (S1) chooses either to create new data or update (modify) existing data (S2). If creating new data, choose a desired form from among provided samples (S3). There are five types of forms (Default, One form, Table, List and Image) shown here as an example. If modifying existing data, input ID to choose XML data for updates (S4).

A sent-tagged text or new form is sent from server 10 (S5). A (to-be-) received-tagged text is automatically generated (S7) by inputting the new form or modifying data required to update. When creation or modification of data is completed, the received-tagged text is sent to the server (S8).

Server 10 receives the received-tagged text and determines the compatibility of the text with its stored XML data. If incompatible, the server notifies client 20 of it (S11). If compatible, the server converts it to Java (registered trademark of Sun Microsystems, Inc.) Object, and update the XML data (S12).

### INDUSTRIAL APPLICABILITY

The present invention can be used as a data management system to share data on a server in a system where a server and a client/clients are interconnected through the Internet or a local area network. Especially, the present invention can be used as a system for managing and providing a wide variety and enormous amount of administrative documents/information.

1. A data structure stored on a server and updated by a client connecting to the server through a network,
said data structure being hierarchized into at least data management information and data information, both attached with unique identifiers,
said data information being further hierarchized into at least a plurality of blocks attached with unique identifiers, and
each of the blocks including data body information written in a language displayable by a web browser.

2. The data structure of claim 1, being written in XML.

3. The data structure of claim 1, wherein said data body information is written in HTML or XHTML.

4. The data structure of any one of claims 1 to 3, wherein said data information is hierarchized into at least a plurality of sections attached with unique identifiers, and the blocks are arranged under the respective sections.

5. A structured data management system including a server having hierarchically structured data and a client connecting to the server through a network and updating the structured data on said server, wherein
said structured data are hierarchized into at least data management information and data information,
said data information includes a plurality of data body information pieces each of which is attached with a unique identifier,
said client has means for making a request to update a data body information piece based on the unique identifier,
said server has means for, in response to the request, sending a text within the data body information piece and predefined tags attached to the text, and
said client has:
means for receiving the text with the predefined tags sent from said server (hereinafter referred to as “sent-tagged text”), displaying the text, and accepting updates; and
means for, when the text is updated, sending data of the text attached with the predefined tags (hereinafter referred to as “received-tagged text”).

6. The structured data management system of claim 5, wherein said server further has means for, upon receiving the request from said client to update the plurality of data body information pieces based on respective identifiers, combining texts within the data body information pieces into the sent-tagged text and sending the sent-tagged text to said client.

7. The structured data management system of claim 5, wherein said server has:
means for determining whether or not the received-tagged text is compatible with the structured data stored on the server; and
means for, if the received-tagged text is not compatible, notifying said client of incompatibility and, if the received-tagged text is compatible, updating the data body information piece by the received-tagged text.

8. The structured data management system of any one of claims 5 to 7, wherein the structured data are written in XML.

9. The structured data management system of claim 5, wherein displaying of the text utilizes a web browser.

10. A structured data management method in a system where a server having structured data and a client updating the structured data on the server are interconnected through a network, comprising:
hierarchizing the structured data into at least data management information and data information;
dividing the data information into a plurality of data body information pieces and assigning each of the data body information pieces with a unique identifier;
allowing said client to make a request to update a data body information piece based on the unique identifier,
allowing said server, upon receiving the request, to send a text within the data body information piece with predefined tags attached to the text;
allowing said client to receive the text attached with the predefined tags sent from the server (hereinafter referred to as “sent-tagged text”), display the text within the sent-tagged text on a display device and accept updates, and when the text is updated, to send data of the text updated with the predefined tags to the server (hereinafter referred to as “received-tagged text”); and
allowing said server to update said data body information piece by the received-tagged text.

11. The structured data management method of claim 10, further comprising allowing said server to determine whether or not the received-tagged text is compatible with the structured data and, if the received-tagged text is compatible, to update the data body information piece by the received tagged text, and if the received-tagged text is not compatible, notify the client of incompatibility.

12. The structured data management method of claim 10 or 11, further comprising, when the request from the client is to update the plurality of data body information pieces, allowing the server to combine texts within the data body information pieces into one text and send the text as the sent-tagged text.

13. The structured data management method of claim 10, further comprising allowing said client to receive the sent-tagged text, display the text, and accept input for updates through a web browser.

14. A structured data management program allowing a server for managing hierarchical structured data to function as:
means for hierarchizing said structured data stored on the server into at least data management information and data information;
means for assigning unique identifiers to data body information pieces composing said data information;
means for accepting a request from a client interconnected through a network to update one of the data body information piece based on a corresponding unique identifier; and
means for attaching predefined tags to the text within the data body information and sending the text to the client in response to the request.

15. The structured data management program allowing a client interconnected with a server through a network to function as:
means for receiving a text attached with predefined tags and sent from the server (hereinafter referred to as “sent-tagged text”);
means for receiving the sent-tagged text, displaying the text within the sent-tagged text and accepting updates; and
means for sending the text updated and attached with the predefined tags to the server (hereinafter referred to as “received-tagged text”).

16. The structured data management program of claim 14, allowing said server to function as means for, on request from said client to update the data body information pieces based on the identifiers, combining texts within the data body information pieces into one text, and sending the text to said client as a sent-tagged text.

17. The structured data management program of claim 14, allowing said server to function as:
means for receiving a received tagged text and determining whether or not the received tagged text is compatible with the structured data; and
means for, if the received tagged text is not compatible, notifying said client of incompatibility and, if the received tagged text is compatible, updating the data body information pieces by said received-tagged text.
